(19) United States
(12) Patent Application Publication
(10) Pub. No.: US 2024/0373193 A1
(43) Pub. Date: Nov. 7, 2024

(54) SYSTEM AND METHOD FOR OBTAINING LOCATION DATA, BASED ON IDENTIFIERS TRANSMITTED FROM MOBILE DEVICE

(71) Applicant: B.G. Negev Technologies Ltd , at Ben-Gurion University, Beer Sheva (IL)

(72) Inventor: Mordechai GURI, Nof Ayalon (IL)

(21) Appl. No.: 18/681,057

(22) PCT Filed: Aug. 4, 2022
(86) PCT No.: PCT/IL2022/050845

§ 371 Date: Feb. 4, 2024

Related U.S. Application Data
(60) Provisional application No. 63/229,672, filed on Aug. 5, 2021.

(51) Int. Cl. H04W 4/029

(52) U.S. Cl. CPC H04W 4/029

(57) ABSTRACT

A system is provided for obtaining location data, based on identifiers transmitted from mobile devices. The system includes a plurality of wireless transceivers deployed in selected predetermined locations in sites of interest. The transceivers are adapted to receive and collect wireless signals transmitted during communication by mobile devices of users being within the vicinity of each wireless transceiver which is in communication range. A processor in each wireless transceiver is adapted to process the signals in predefined protocols and extract the identifiers of each transmitting device that were defined during a configuration process. A memory or a database, is in wired or wireless data communication with the plurality of wireless transceivers. A data analysis module for accessing the memory or the database and performing predefined analytics on extracted identifiers and/or collected raw data is also provided.

### FIELD OF THE INVENTION

The present invention relates to the field of location identification. More particularly, the invention relates to a system and method for obtaining users' location data, based on identifiers transmitted from mobile devices of these users.

### BACKGROUND OF THE INVENTION

Modern environments in populated urban areas, such as cities, are equipped with vast electronic devices that wirelessly transmit Radio Frequency (RF) signals that carry voice and/or data. These devices may be mobile or stationary and may include smartphones, tablets and handheld devices, or smart-home devices, IoT devices (IoT devices are the computing devices that connect wirelessly to a network and have the ability to transmit data physical objects with sensors, processing ability, software, and technologies that connect and exchange data with other devices and systems over the Internet or other communications networks), cameras, TV, and smart city (a smart city is a technologically modern urban area that uses different types of electronic methods and sensors to collect specific data. The information gained from that data is used to manage assets, resources and services efficiently. That data is used to improve operations across the city) devices and so on. These devices include a wide range of wireless interfaces that transmit and receive wireless communication data over the air.

Many official authorities and service providers use modern methods to collect and analyze data regarding the users of such devices, in order to improve services provided to these users, and make them more efficient. The collected data is typically location-based, and is directed to identify the massive presence of users in areas of interest, such as shopping malls, transportation centers, airports, traffic junctions, etc. The analysis of the collected data provides very important information and insights regarding the behavioral patterns of users in an area of interest. For example, it is possible to identify which mall in a city is the most visited, by how many users and at what timing and location inside the mall. Such information may be important to service providers, such as store owners and to design better advertisement policies.

Another example is related to law enforcement applications, such as preventing the unwanted gathering of people in certain areas, for example, under COVID-19 regulations.

However, this data is typically collected using records of cellular providers that have access to the location data of each device, based on the inherent GPS receivers within the mobile devices. Many times, access to these records is limited and is subject to authorization from the users, to share their location. Also, such access raises privacy problems, which strictly limit the ability to collect sufficient data regarding the location and movements of masses of users.

Other methods are more invasive and involve intrusion into mobile devices, in order to extract location data. These invasive methods are restricted only to official authorities such as police and terror-prevention forces, which makes them unavailable.

It is therefore an object of the present invention to provide a system and method for obtaining location data of users, based on identifiers transmitted from their mobile devices.

It is another object of the present invention to provide a system and method for obtaining location data of users of mobile devices, which are non-invasive.

It is a further object of the present invention to provide a system and method for obtaining location data of users of mobile devices, which meet privacy requirements.

Other objects and advantages of the invention will become apparent as the description proceeds.

### SUMMARY OF THE INVENTION

A system for obtaining location data, based on identifiers transmitted from mobile devices, comprising:
a) a plurality of wireless transceivers being deployed in selected predetermined locations in sites of interest and adapted to receive and collect wireless signals transmitted during communication by mobile devices of users being within the vicinity of each wireless transceiver which is in communication range, where a processor in each wireless transceiver is adapted to process the signals in predefined protocols and extract the identifiers of each transmitting device that were defined during a configuration process;
b) a memory or a database, being in wired or wireless data communication with the plurality of wireless transceivers, for storing the extracted identifiers and/or the collected raw data from all wireless transceivers that are transmitted and in along with their corresponding timestamps or source information; and
c) a data analysis module for accessing the a memory or a database and performing predefined analytics on the extracted identifiers and/or the collected raw data, to find correlations between identifiers, users and mobile devices and obtaining location data to identify the location and movement patterns of the users over time, based on the correlations.

The predefined analytics may be performed using one or more of the following:
machine learning;
artificial intelligence (AI);
deep learning;
signal processing.

The data analysis module may reside on a computational cloud or on remote servers.

The identifiers may be collected from different communication layers.

The sites of interest may typically expected to have a massive presence of users.

The sites of interest may be selected from the group of:
shopping malls;
transportation centers;
traffic junctions;

The mobile devices may be one or more of the following:
smartphones;
tablets;
connected vehicles;
wearable devices;
drones;
cameras;
connected vehicles;
IoT devices.

Correlations between identifiers over time may be used to obtain information about the location and movements of users, vehicles, drones and any connected devices in the areas of interest.

The calculation of directions may be performed when the identifiers of the same mobile device were received by several wireless transceivers.

The extracted identifiers allow tracking the location and movements of a particular user or vehicle.

The correlation between identifiers allows detecting that the identifiers have the same movement pattern and determining that a particular smartphone belongs to a particular driver.

The correlation between identifiers of different users allows detecting that the users met each other, for how long and at which location.

The identifiers of different users can allow analyzing and detecting which type and model of the mobile device are owned by each user.

In smart cities that are networked with deployed cameras, a correlation between identifiers of different users and vehicles that were captured by different cameras allows:
detecting which user traveled in which vehicle and at what time;
collecting and analyzing data and identifiers in order to profile the presence and movements of users in crowded areas.

The identifiers may be selected from the group of:
a wireless data carrying signal in any frequency and any communication protocol;
   a MAC address;
   an IP address;

### IMEI;

### IMSI;

traffic identifiers;
cookies;
sequence numbers;
user identifiers;
signal strength;

### RSSI.

The signals transmission protocol may be selected from the group of:
cellular;
WiFi;
Bluetooth;
Near-field communication (NFC);
ZigBee;
LoRa.

The wireless transceiver may comprise:
at least one RF receiver module having appropriate hardware and operating software that are adapted to receive the wireless transmissions in different frequency bands;
a local identifiers' extraction module, which analyzes the collected wireless data and extracts the identifiers of all mobile devices in range from the collected data traffic.

The identifiers may be in different layers of the communication.

The analyzed data may include RSSI level emitted from a mobile device that allows estimating the distance from a particular wireless transceiver that measures the signal strength, estimating the location and direction of movement using triangulation.

The system may comprise wireless receivers which receive and collect that data traffic, while communicating with each other, with the database and with the data analysis module via wired communication channels.

The system may be further adapted to generate data logs and alerts, based on events that are identified during performing analytics by the data analysis module.

Data collection may be performed regarding groups of users, rather than particular users.

All identifiers may be encrypted before storing them and analytics are performed on the encrypted values, while still being able to correlate between them.

The wireless transceivers may be stationary or moving.

The wireless transceivers may be replaced by wireless receivers which are connected to other receivers and/or to the database via a wired connection.

A method for obtaining location data, based on identifiers transmitted from mobile devices, comprising:
a) deploying a plurality of wireless transceivers being in selected predetermined locations in sites of interest;
b) receiving and collecting, by the wireless transceivers, signals transmitted during communication by mobile devices of users being within the vicinity of each wireless transceiver which is in communication range;
c) processing, by a processor in each wireless transceiver, the signals in predefined protocols and extracting the identifiers of each transmitting device that were defined during a configuration process;
d) storing a memory or a database, being in wired or wireless data communication with the plurality of wireless transceivers, the extracted identifiers and/or the collected raw data from all wireless transceivers that are transmitted and in along with their corresponding timestamps or source information; and
e) accessing the a memory or a database and performing, by a data analysis module, predefined analytics on the extracted identifiers and/or the collected raw data;
f) finding correlations between identifiers, users and devices; and
g) based on the correlations, obtaining location data to identify the location and movement patterns of the users over time.

### BRIEF DESCRIPTION OF THE DRAWINGS

The above and other characteristics and advantages of the invention will be better understood through the following illustrative and non-limitative detailed description of preferred embodiments thereof, with reference to the appended drawings, wherein:

FIG. 1 illustrates a typical block diagram of a system for obtaining location data of users, based on identifiers transmitted from their mobile devices of the present invention; and

FIG. 2 is a block diagram of a deployed wireless transceiver of the system.

### DETAILED DESCRIPTION OF THE INVENTION

The present invention provides a system and method for obtaining location data, based on identifiers transmitted from mobile devices. By using the term “identifiers” it is meant to include any type of wireless data carrying signal in any frequency (such as RF) and any communication protocol which has coded or uncoded data associated with a specific device (such as MAC address IP addresses, IMEI, IMSI, traffic identifiers, cookies, sequence numbers, user identifiers). An identifier may reflect other communication parameters associated with the transmitted RF signal, such as signal strength, RSSI, etc. An identifier of a device may also be present in each data packet that is sent from that device or only in some of them, according to a predetermined rate.

The mobile device that normally transmits wireless data may be, for example, a cellular phone, a smartphone, a tablet, a drone, a wearable device (such as a smartwatch), a camera, connected vehicles 110 (such as connected cars, connected scooters, connected electric bicycles) and IoT device. The transmitted signals may include any transmission protocol, such as cellular, WiFi, Bluetooth, or Near-Field Communication (NFC-a short-range wireless connectivity technology that uses magnetic field induction to enable communication between devices when they're touched together or brought within a few centimeters of each other), ZigBee (a wireless technology developed as an open global market connectivity standard to address the unique needs of low-cost, low-power wireless IoT data networks) and LoRa (is a physical proprietary radio communication technique. It is based on spread spectrum modulation techniques) bands (which may be pre-defined or adaptively configured) or frequency bands of specified or unspecified protocols.

The system provided by the present invention comprises a plurality of wireless transceivers which receive and collect wireless signals normally transmitted during communication by any mobile device within the vicinity of each wireless transceiver which is in communication range. The wireless transceivers are deployed in selected predetermined locations which are typically expected to have a massive presence of users, such as malls, transportation centers and traffic junctions. The wireless transceivers may be stationary or moving, with known locations during all times. A processor in each wireless transceiver is adapted to process the signals in any predefined protocols and extract the identifiers of each transmitting device that were defined during a configuration process. The identifiers may be collected from different communication layers, starting from the physical layer to higher layers such as the application layer.

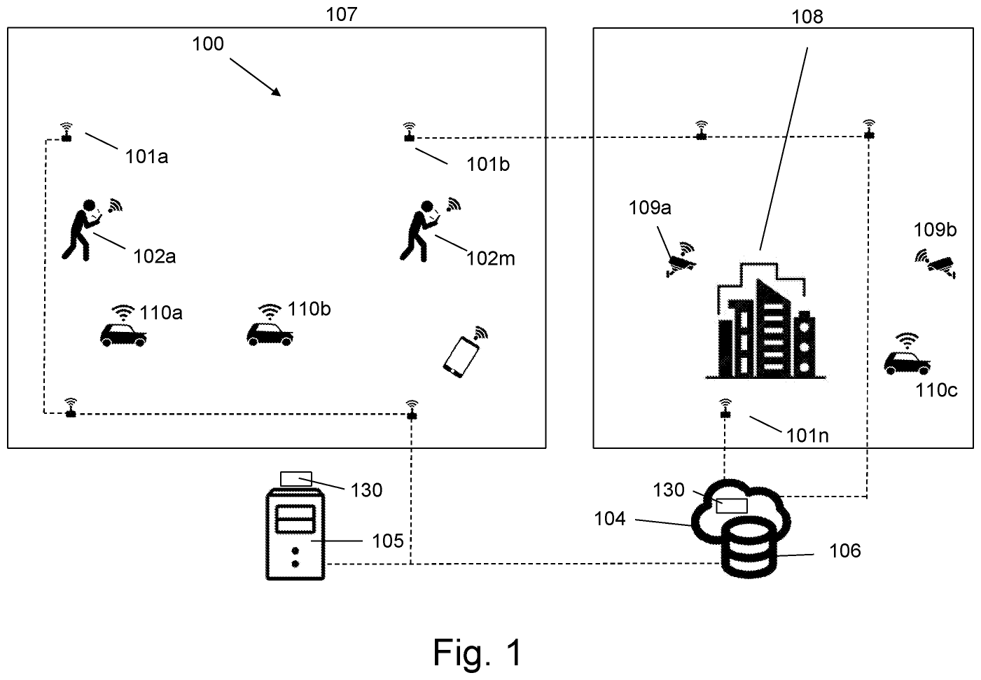

FIG. 1 illustrates a typical block diagram of the system provided by the present invention. The system 100 comprises wireless transceivers 101a, . . . , 101n which are deployed at known locations at sites of interest. In this example, the site of interest may be a shopping mall 107, a smart city 108 with a network of cameras 109, a train station, or an airport, where masses of users of mobile devices are expected to pass. Most of the time, each wireless transceiver 101a, . . . , 101n receives data that is continuously or periodically transmitted from mobile devices 102a, . . . 102m. The received data is processed by a processor 203 in each of wireless transceivers 101a, . . . , 101n that is adapted to extract all the identifiers of all mobile devices in the receiving range. Then, the extracted identifiers and/or the collected raw data from all wireless transceivers 101a, . . . , 101n are transmitted and stored in a memory or a database 106, for further analysis. The extracted identifiers and/or the collected raw data from all wireless transceivers 101a, . . . , 101n are stored along with their corresponding timestamps or source information (from which device they were transmitted), in order to identify location and movement patterns over time, based on correlations between identifiers, users and mobile devices.

A data analysis module 130 that resides locally at one or more of the wireless transceivers 101a, . . . , 101n or on a computational cloud 104 or on remote servers 105, accesses the memory or database and performs predefined analytics on the extracted identifiers and/or the collected raw data, to find correlations between identifiers, users and devices, using, for example, machine learning, artificial intelligence (AI), deep learning, signal processing and other methods. Alternatively, the data analysis module 130 may reside on one or more of the wireless transceivers 101a, . . . , 101n, such that the predefined analytics are performed locally.

The correlation between identifiers over time (as extracted by different wireless transceivers with known location) is used while performing such analytics, to obtain information about the location and movements of users, vehicles, drones and any kind of connected devices in areas of interest. Correlation may include associating identifiers to the same user.

For example, such analytics may be performed to measure how many users or vehicles passed in a defined location, at which speed and even in which direction (calculation of directions is possible in cases when the identifiers of the same mobile device were received by several wireless transceivers).

According to another embodiment, the extracted identifiers allow tracking of the location and movements of a particular user or vehicle. Since a user may own several mobile devices (such as a smartphone and a smartwatch) with different identifiers, the data analysis module 130 will be adapted to perform a correlation between them in order to know that those several mobile devices belong to the same person.

In another example, if a particular user of a smartphone also drives a vehicle, the correlation between his identifiers can allow detecting that they both have the same movement pattern and that a particular smartphone belongs to that driver.

In another example, a correlation between identifiers of different users can allow detecting that these users met each other, for how long and at which location.

In another example, a correlation between identifiers of different users and vehicles can allow detecting which user traveled in which vehicle and how many users traveling in the same vehicle.

In another example, the identifiers of different users can allow analyzing and detecting which type and model of a mobile device are owned by each user and estimating his age (assuming that more advanced mobile devices are used by young users). Also, the model of the vehicle used by each user may be known, in order to estimate to which socioeconomic status he belongs. This type of analytics may be used by service providers who can access the database and plan their campaigns more accurately.

In another example, in smart cities that are networked with deployed cameras, a correlation between identifiers of different users and vehicles that were captured by different cameras can allow detecting which user traveled in which vehicle and at what time. This also allows collecting and analyzing data and identifiers in order to profile the presence and movements of users in crowded areas, such as malls, airports, train stations, etc.

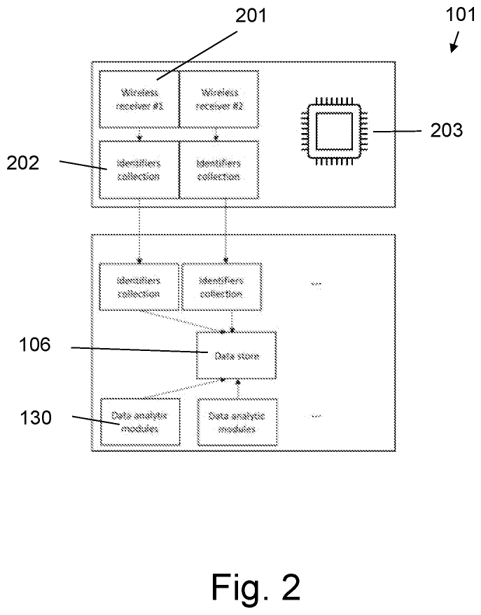

FIG. 2 is a block diagram of a wireless transceiver 101. The wireless transceiver 101 comprises at least one wireless receiver 201, such as an RF receiver module. This module has appropriate hardware and operating software that are adapted to receive the wireless transmissions in different frequency bands.

The wireless transceiver 101 also comprises a local identifiers' extraction module 202, which analyzes the collected wireless data and extracts the identifiers of all mobile devices in range from the collected data traffic. The received data is processed by a processor in each of wireless transceivers 101a, . . . , 101n that is adapted to extract all the identifiers of all mobile devices in the receiving range.

The identifiers may be in different layers of the communication, such as device MAC addresses, IP addresses, International Mobile Equipment Identity (IMEI), International Mobile Subscriber Identity (IMSI), and other traffic identifiers, cookies, sequence numbers, user identifiers and so on. The analyzed data may include other properties of physical layers, such as the Received Signal Strength Indicator (RSSI—is a measurement of the power present in a received radio signal), signal strength, errors and so on. The RSSI level emitted from a mobile device allows estimating the distance from a particular wireless transceiver that measures the signal strength, and if the RSSI level is received by more than one wireless transceiver, the data analysis module 130 can estimate the location and direction of movement using triangulation.

According to another embodiment, a remote identifiers' extraction module 203 that resides on a computational cloud, or on one or more remote servers, may be used to analyze the wireless data and extract the identifiers from the data traffic. In this case, all the wireless transceivers 101a, . . . , 101n only collect the transmitted (raw) data from all mobile devices in range and then transmit the collected raw data to the remote identifiers' extraction module 203.

According to another embodiment, rather than using wireless transceivers, the system 100 comprises wireless receivers 103a, . . . , 103n which receive and collect that data traffic, while communicating with each other, with the database and with the data analysis module 130 via wired communication channels, such as fiber optics.

According to another embodiment, system 100 further comprises wired or wireless networking interfaces to communicate with other systems, such as of cellular providers and/or official authorities. The system 100 is further adapted to generate data logs and alerts, based on events that are identified during performing analytics by the data analysis module 130.

According to another embodiment, each of wireless receivers 103a, . . . , 103n will have an interface, through which it will be possible to remotely re-configure it, add new identifiers and remove existing identifiers.

In order to keep the desired privacy level, data collection may be performed regarding groups of users, rather than particular users. According to another embodiment, all identifiers may be encrypted (e.g., by hashing) before storing them. In this case, the analytics will be performed on the encrypted values, while still being able to correlate between them.

As various embodiments and examples have been described and illustrated, it should be understood that variations will be apparent to one skilled in the art without departing from the principles herein. Accordingly, the invention is not to be limited to the specific embodiments described and illustrated in the drawings.

1.-27. (canceled)

28. A system for obtaining location data, based on identifiers transmitted from mobile devices, comprising:
a) a plurality of stationary or moving wireless transceivers being deployed in selected predetermined locations in sites of interest and adapted to receive and collect wireless signals transmitted during communication by mobile devices of users being within the vicinity of each wireless transceiver which is in communication range, where a processor in each wireless transceiver is adapted to process the signals in predefined protocols and extract the identifiers of each transmitting device that were defined during a configuration process;
b) a memory or a database, being in wired or wireless data communication with said plurality of wireless transceivers, for storing the extracted identifiers and/or the collected raw data from all wireless transceivers that are transmitted and in along with their corresponding timestamps or source information; and
c) a data analysis module for accessing said a memory or a database and performing predefined analytics on the extracted identifiers and/or the collected raw data, to find correlations between identifiers, users and mobile devices and obtaining location data to identify the location and movement patterns of said users over time, based on said correlations.

29. A system according to claim 28, in which the predefined analytics are performed using one or more of the following:
machine learning;
artificial intelligence (AI);
deep learning; and
signal processing.

30. A system according to claim 28, in which the data analysis module resides on a computational cloud or on remote servers.

31. A system according to claim 28, wherein the sites of interest are selected from the group consisting of:
shopping malls;
transportation centers; and
traffic junctions.

32. A system according to claim 28, in which the mobile devices are one or more of the following:
smartphones;
tablets;
connected vehicles;
wearable devices;
drones;
cameras;
connected vehicles; and
IoT devices.

33. A system according to claim 28, wherein correlations between identifiers over time are used to obtain information about the location and movements of users, vehicles, drones and any connected devices in the areas of interest.

34. A system according to claim 28, wherein the calculation of directions is performed when the identifiers of the same mobile device were received by several wireless transceivers.

35. A system according to claim 28, wherein the extracted identifiers allow tracking the location and movements of a particular user or vehicle.

36. A system according to claim 28, wherein the correlation between identifiers of different users allows:
detecting that said identifiers have the same movement pattern and determining that a particular smartphone belongs to a particular driver; and
detecting that said users met each other, for how long and at which location.

37. A system according to claim 28, wherein the identifiers of different users allow analyzing and detecting which type and model of the mobile device are owned by each user.

38. A system according to claim 28, wherein in smart cities that are networked with deployed cameras, a correlation between identifiers of different users and vehicles that were captured by different cameras allows:
detecting which user traveled in which vehicle and at what time; and
collecting and analyzing data and identifiers in order to profile the presence and movements of users in crowded areas.

39. A system according to claim 28, wherein the identifiers are selected from the group consisting of:
a wireless data carrying signal in any frequency and any communication protocol;
a MAC address;
an IP address;
IMEI;
IMSI;
traffic identifiers;
cookies;
sequence numbers;
user identifiers;
signal strength; and
RSSI.

40. A system according to claim 28, wherein the signals transmission protocol is selected from the group consisting of:
cellular;
WiFi;
Bluetooth;
Near-Field Communication (NFC);
ZigBee; and
LoRa.

41. A system according to claim 28, wherein the wireless transceiver comprises:
at least one RF receiver module having appropriate hardware and operating software that are adapted to receive the wireless transmissions in different frequency bands; and
a local identifiers' extraction module, which analyzes the collected wireless data and extracts the identifiers of all mobile devices in range from collected data traffic.

42. A system according to claim 28, wherein the analyzed data includes RSSI level emitted from a mobile device that allows estimating the distance from a particular wireless transceiver that measures the signal strength, estimating the location and direction of movement using triangulation.

43. A system according to claim 28, comprising wireless receivers which receive and collect data traffic, while communicating with each other, with the database and with the data analysis module via wired communication channels.

44. A system according to claim 28, further adapted to generate data logs and alerts, based on events that are identified during performing analytics by the data analysis module.

45. A system according to claim 28, wherein all identifiers are encrypted before storing them and analytics are performed on the encrypted values, while still being able to correlate between them.

46. A method for obtaining location data, based on identifiers transmitted from mobile devices, comprising:
a) deploying a plurality of wireless transceivers being in selected predetermined locations in sites of interest;
b) receiving and collecting, by said wireless transceivers, signals transmitted during communication by mobile devices of users being within the vicinity of each wireless transceiver which is in communication range;
c) processing, by a processor in each wireless transceiver, the signals in predefined protocols and extracting the identifiers of each transmitting device that were defined during a configuration process;
d) storing a memory or a database, being in wired or wireless data communication with said plurality of wireless transceivers, the extracted identifiers and/or the collected raw data from all wireless transceivers that are transmitted and in along with their corresponding timestamps or source information; and
e) accessing said a memory or a database and performing, by a data analysis module, predefined analytics on the extracted identifiers and/or the collected raw data;
f) finding correlations between identifiers, users and devices; and
g) based on said correlations, obtaining location data to identify the location and movement patterns of said users over time.

47. A method according to claim 46, wherein the wireless transceiver are replaced by wireless receivers which are connected to other receivers and/or to the database via a wired connection.
